(19) United States
(12) Patent Application Publication
(10) Pub. No.: US 2025/0319753 A1
(43) Pub. Date: Oct. 16, 2025

(54) SIDE ACCESS TONNEAU COVER

(71) Applicant: JOSEPH LUKE BALAY, Sugarloaf, PA (US)

(72) Inventor: JOSEPH LUKE BALAY, Sugarloaf, PA (US)

(21) Appl. No.: 19/059,560

(22) Filed: Feb. 21, 2025

Related U.S. Application Data
(60) Provisional application No. 63/556,626, filed on Feb. 22, 2024.

(51) Int. Cl. B60J 7/14; B60J 7/00

(52) U.S. Cl. CPC B60J 7/141; B60J 7/0084

(57) ABSTRACT

A tonneau cover attached to a vehicle bed for protection from the elements and theft. The cover comprises a set of lids hingedly connected to a center panel which is rigidly attached to front and rear panels. The tonneau cover is structurally attached to the vehicle bed for the purpose of carrying additional gear on top. The lids hingedly attach to the center panel allowing access from the sides of the vehicle bed. Panels include channels to divert water to the exterior and are structurally connected to the top of the vehicle bed by water exit components. A series of gaskets attach to the underside of the cover to seal the vehicle bed from the elements. Water exit components limit the amount of gasket compression improving sealing and gasket life. Use of a rack system does not limit use of the side access tonneau cover lids.

### CROSS REFERENCE TO RELATED APPLICATIONS

Provisional Patent Application: 63/556,626

### PRIOR ART

U.S. Pat. No. 6,883,855B2 Hinged tonneau cover for transporting a significant top load
U.S. Pat. No. 9,925,853B2 Load bearing tonneau structure
U.S. Pat. No. 10,328,778B2 Load bearing tonneau cover with integral track, improved latch to vehicle and custom frame attachment
U.S. Pat. No. 7,252,322B2 Hard tonneau cover
U.S. Pat. No. 10,414,256B2 Dynamically configurable tonneau cover
U.S. Pat. No. 9,211,834B2 Tri-fold hard tonneau cover with hinged front opening

### BACKGROUND OF THE INVENTION

Tonneau covers are used to enclose the top of a vehicle bed protecting items stored beneath from theft and the elements. For example, tonneau covers are constructed of various materials and provide access to the vehicle bed in many ways.

Tonneau cover options exist that roll up, fold, stack, hinge open to the cab and/or hinge open from both the cab and tailgate toward the middle of the vehicle bed.

Some existing options allow for improved load carrying capacity on top of the cover and with the addition of rack system. In most cases, the top surface of the cover has protrusions of fasteners, hinges, locks and cleats. Any of these items can hinder the additional carrying of gear or equipment and can be prone to damage.

While some of the existing tonneau covers in the market allow access through the top of the cover using lids, the addition of an accessory rack limits this access.

Current tonneau cover options clamp to the vehicle bed and do not limit the amount of compression of the gaskets sealing the cover to the vehicle bed. By not limiting compression, the gaskets can be flattened causing them to wear out faster and may not seal properly. Carrying significant loads on top of the cover, walking on the cover or hauling an ATV/UTV will compress the gasket further, potentially loosening the clamps/brackets mounting the cover to the vehicle bed. Covers currently not limiting this gasket compression also cause the tailgate of the vehicle to become difficult to open due to the increased friction from the gasket flattening out.

### SUMMARY OF THE INVENTION

This invention relates generally to tonneau covers, and in particular to covers constructed with side access lids. Some applications exist with top access lids in the front, rear and/or sides of the vehicle bed, but they provide limited access to the vehicle bed through a small opening in the cover. The side access lids provide a larger opening for gear to be placed in or removed from the vehicle bed.

Other limitations occur when a rack is added to the vehicle bed. While the racks can be mounted to the cover or the vehicle bed, they become prohibitive to open the lids due to clearance with the rack system. Rack systems further limit the lids from opening by only allowing access when they are not carrying additional gear. The side access lids for this invention improve access to the vehicle bed by allowing use when a rack is installed.

Some of the existing cover options have hinges and locks exposed on top. They can be damaged and make it more difficult to slide or place gear on top of the cover. The hinges and locks of the present disclosure are contained within the interior of the cover, eliminating this problem. For example, roof top tents can be mounted directly on the cover versus requiring the addition of a rack to suspend the tent above the hinge and locks. It should be noted that hinges and locks mounted to the top of the cover can also be used to perform the same operation for the side access cover, but do not carry the benefits described of internally mounted components.

The side access lids are used with a front and a rear rigid panel where the attachment points for racks are typically installed. The side access lids are still able to open beneath the rack, whether equipment/gear is attached to the rack. The present disclosure provides an increased area for larger items to be loaded or removed from the vehicle bed.

The separate panel design improves shipping and single person installation, allowing easier removal of the cover to provide full bed use when desired. The front and rear panels are easily attached to the bed rail of the vehicle, with the center panel being mounted between them on the front/rear panel water diversion channels.

The side access lids close into a series of water diversion channels preventing any moisture from entering the bed of the vehicle while closed. When opening the side access lids, these channels will handle any moisture on them and divert it away from the interior of the vehicle bed.

Several options are available to lock the side access lids securing the cargo beneath the cover. Push to close latches with keyed cylinders to unlock are used to open the side access lids. The push to close latch allows returning the side access lids to a closed state without the need to turn the cylinder. Electronic locking operated by a key fob or app to unlock the push to close latches is another variation available.

The water diversion channels on the front and rear panels run the width of the vehicle bed to allow water to flow freely in either direction. The side access lids are supported by the front/rear panel diversion channels improving the structure of the cover.

The structural members used to create the load carrying capacity of the tonneau cover, can also be used to attach or retain gear within the vehicle bed. This eliminates the need for additional members to be added to carry additional equipment beneath the cover.

Additionally, gear drawers can be attached to the structural members of the panels rigidly or with rollers/slides. The rollers/slides allow the drawer to be moved from one side to the other to access, through the side access lids, or to the bottom of the vehicle bed when desired. More than one bin can be used to provide additional storage with entry through either side access lid.

### BRIEF DESCRIPTION OF THE FIGURES

FIG. 1 illustrates an isometric view of the cover on a vehicle bed

FIG. 2 illustrates an isometric view of the cover with open side access lids on a vehicle bed and optional gear drawer shown

FIG. 3 illustrates an isometric view of the cover with open side access lids and a rack installed and optional gear drawer shown

FIG. 301 illustrates a rear view of the cover with open side access lids and a rack installed and optional gear drawer shown

FIG. 302 illustrates a side view of the cover with open side access lids and a rack system attached to the front and rear panels

FIG. 4 illustrates an isometric view of the cover with side access lids closed with lock

FIG. 5 illustrates an isometric view of the cover with the side access lids open

FIG. 6 illustrates a top view of the cover with side access lids removed

FIG. 7 illustrates a side view of the cover with side access lids removed

FIG. 8 illustrates a detailed view of the center and front/rear water diversion channels identified in FIG. 7

FIG. 9 illustrates an isometric view of the cover with side access lids removed

FIG. 10 illustrates a detailed view of the water exit component identified in FIG. 9

FIG. 11 illustrates a detailed view mounting holes with the tie downs identified in FIG. 9 removed for clarity

FIG. 12 illustrates an isometric view showing the hinge open

FIG. 13 illustrates an isometric view showing the hinge closed

FIG. 14 illustrates an isometric view of the cover with hinge open

FIG. 15 illustrates a detailed view of the hinge and mounting locations identified in FIG. 10

FIG. 16 illustrates an isometric view of the underside of a side access lid assembly with gasket, hinges and structural channel

FIG. 17 illustrates a detail view of the latch and key cylinder mechanism for locking and unlocking the side access lids for security, shown with cover removed

### DETAILED DESCRIPTION OF THE INVENTION

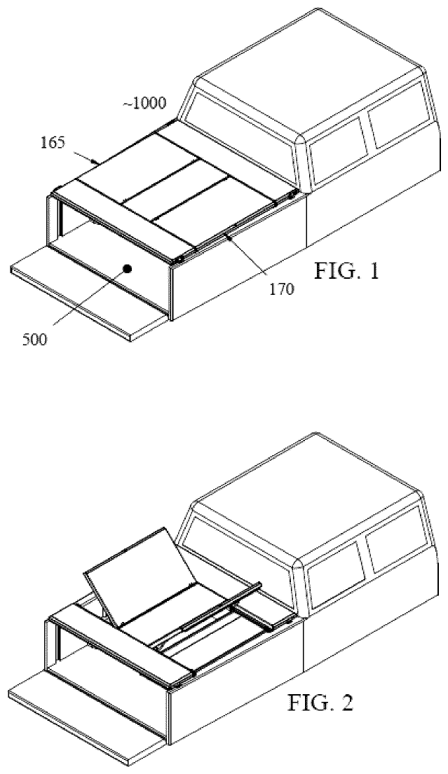

FIG. 1 illustrates the side access tonneau cover 1000 of the disclosed embodiments to cover a vehicle bed 500. The construction of the cover includes a center panel 100 coupled to front and rear panels 110/115. As displayed, the cover is built using Aluminum sheet metal, brake formed and welded. Other variations can be made with different materials, and/or other thicknesses, such as steel or fiberglass. Aluminum was chosen for its light weight and corrosion resistance without additional treatments. Combining extrusions as a perimeter with panels is another optional method of construction. The current method provides less joints to be concerned with for moisture intrusion and strength for additional load carrying capacity.

The panel geometry in FIG. 9-11 is shown with vertical flat faces providing a mounting surface for racks systems 400, tie downs 200 or other gear not considered. The geometry and mounting locations for the tie downs 200, shown in FIG. 7, 9 & 11, allow for a structural connection without having holes or penetrations through the top surface of the panels. Various other panel geometries could be used to construct the side access tonneau cover but would not provide the benefits described herein.

The side access lids 165/170, in FIGS. 1 & 4, are shown in the closed position while shown in the open position in FIGS. 2 & 5. The lid front 171, rear 172 and side 173 flanges, shown in FIGS. 5 & 16, when closed, sit on top of the center 101, front 121 and rear 116 water diversion channels respectively, FIGS. 6, 8 & 9. While the described invention uses lids on both sides of the cover, this is not intended to limit the design from only using a single lid on either side of the cover if desired. This feature allows additional gear to be carried on top of the cover while still allowing access to the vehicle bed when required.

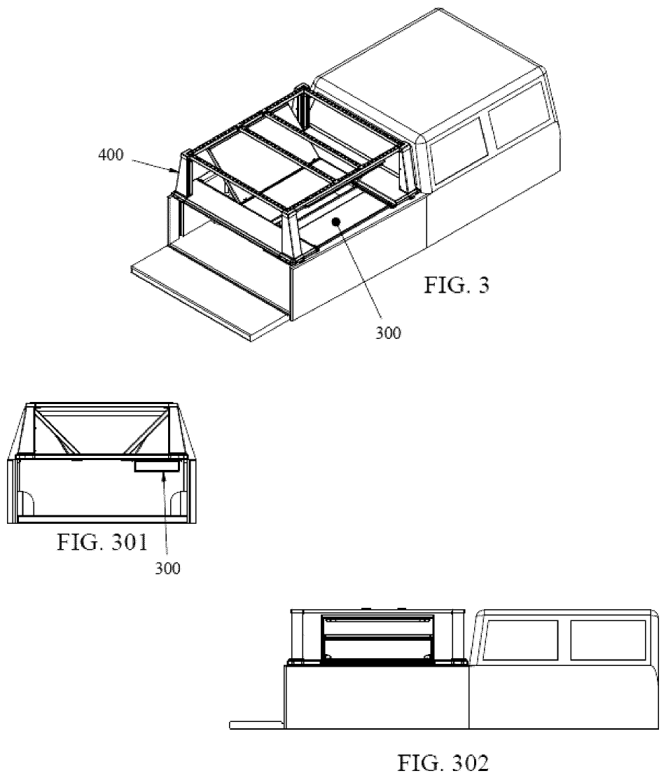

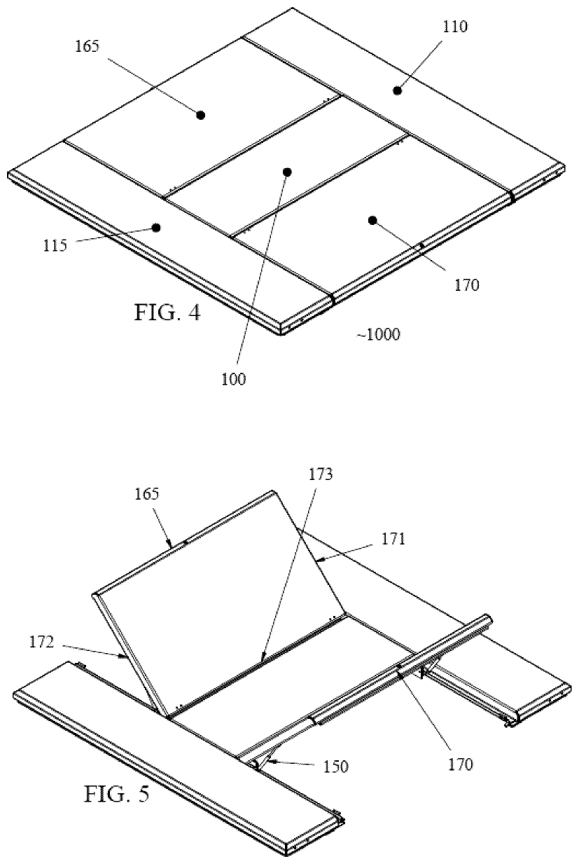

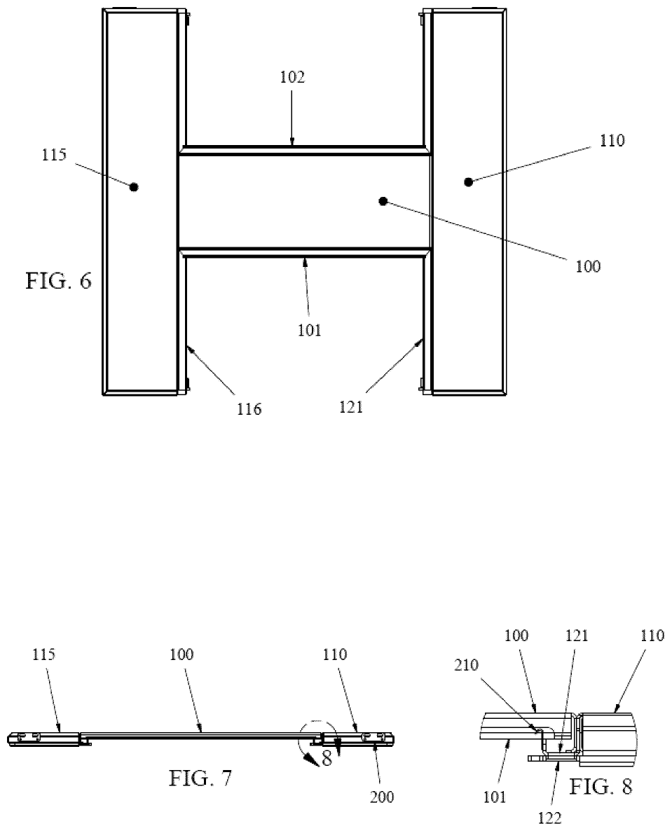

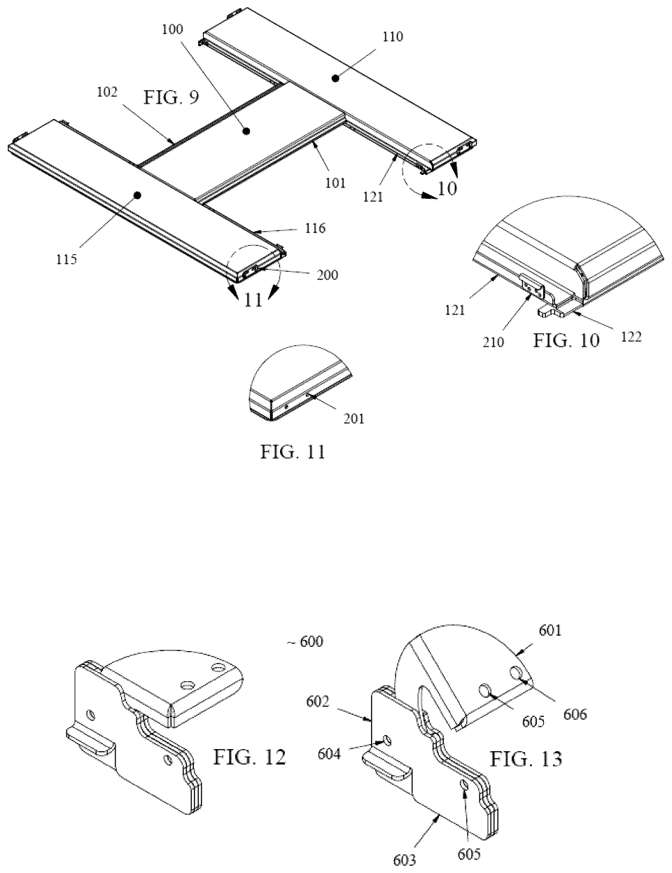

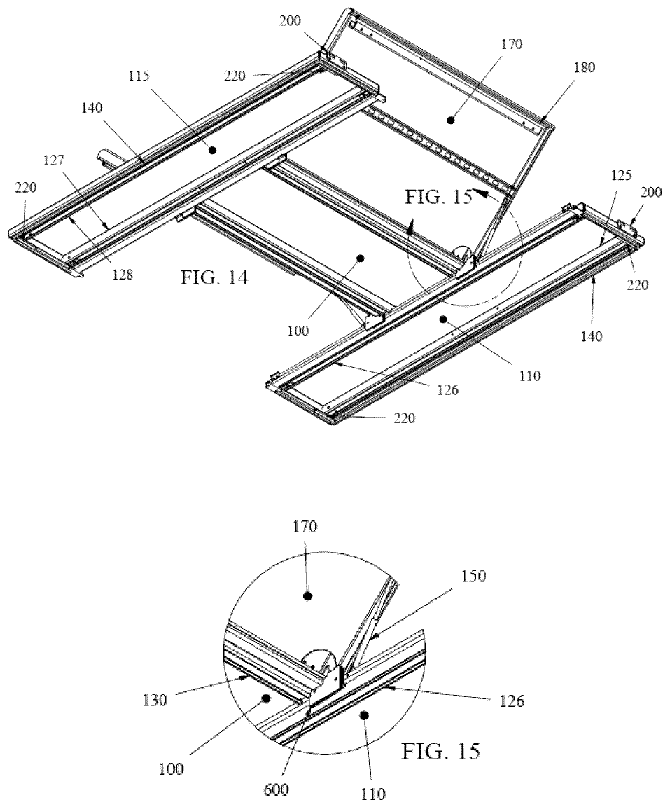

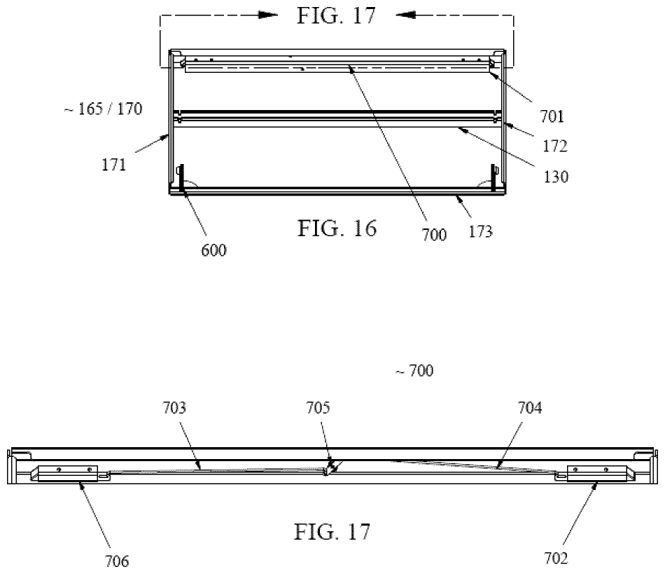

FIG. 3 illustrates the side access lids 165/170 and the ability to open them while there is a rack system 400 mounted to the side access tonneau cover 1000. As shown in FIGS. 301 & 302, the lids 165/170 are open within the rack system 400 allowing access to the bottom of the vehicle bed or to a gear drawer 300.

The channels on the sides of the center panel 101/102 sit on top of the channels of the front and rear panels 110/115 as shown in FIG. 9. This allows any water intrusion around the side access lids 165/170 to be directed to the water diversion channels 116/121 at the center panel 100 and through the water exit components 122 at the end of the water diversion channels 116/121, identified in FIGS. 6 & 10. While the panels and formed channels help with water diversion, other constructions could be built without these channels but would make it more difficult to keep water from reaching the contents of the vehicle bed.

When the side access lids are opened, any water on them will enter channels 101/102 on either side of the center panel 100 as shown in FIGS. 6 & 9. Water entering channels 101/102 travels towards the front or rear of the vehicle, depending on the inclined direction, and enters water diversion channels 116/121 to be diverted to the sides of the vehicle bed 500, FIG. 9.

Beneath the front/rear panels 110/115 there are structural supports 125-128. On the underside of the center panel 100 and the side access lids 165/170 there are additional structural supports 130, indicated in FIGS. 14 & 15. These structural supports provide an increased load carrying capacity to the panels by preventing them from deflecting. A secondary use of the structural supports is for the attachment of gear or tools to the underside of the cover.

There are clamps/brackets near each of the (4) corners of the tonneau cover to attach it to the vehicle bed 500. These provide structural connection to the vehicle and are only accessible from within the vehicle bed 500 to prevent removal. Any of the existing truck bed/rack/cap clamps or brackets can be used to attach the tonneau cover to the vehicle bed 500.

Each corner of the front/rear panels 110/115 have mounting holes 201 for attaching tie downs 200 or a rack system 400 shown in FIG. 3. The tie down 200 geometry is such that it allows for easy attachment of straps or ropes for securing gear to the top of the cover, while not protruding above the top surface, FIG. 11. This feature allows the loading of additional gear or equipment from being placed on the cover without any damage to the tie downs 200. It should be noted that various cleats and other mounting brackets can be used to perform the same function, but do not provide the same benefits.

In one example, the mounting holes 201 can be used to attach tie downs 200. When desired, the tie downs 200 can be removed and a rack system 400, FIG. 3, can be fastened using the mounting holes 201 to the tonneau cover 1000, FIG. 11.

The side access lids 165/170 are attached to the center panel 100 using hinges 600. Opening the side access lid is assisted and can be held open with shocks 150 for easy access, FIG. 15.

The hinges 600 of the present invention are mounted to the interior of the side access lids 165/170. The top leaf of the hinge 601, shown in FIG. 12, is connected to the underside of the side access lids 165/170 using holes 605/606 using countersink fasteners through the top of the side access lid 165/170. The hinges structurally attach to the water diversion channels 121 using holes 604/605 through the main body of the hinge 602 shown in FIGS. 14 & 15. The present invention displays interior mounted hinges although other hinge types such as piano, leaf, concealed or lift off could also be used, but do not provide the benefits of the flush tonneau cover surface and concealment.

The water diversion channels 116/121 on the front and rear panels carry any water from the center panel water diversion channels 101 away from the bed of the vehicle. The water exit component 122 provides a clear path for water to leave the diversion channel 121. The water exit components 122 also limit the amount of compression of the gaskets 140/180 by providing a structural stop when the cover is tightened to the vehicle bed 500. This prevents over compressing the gaskets 140/180 causing damage or improper sealing. On the underside of each of the (4) corners of the tonneau cover, there are additional limiting spacers 220 to limit the gasket 140/180 compression, as shown in FIG. 14. In the enclosed embodiments, the water exit components 122 and the limiting spacers 220 are separate pieces. They can be combined into a single piece but require left- and right-hand parts, therefore the current invention requires less complexity.

Gaskets 140/180 are used to seal the side access tonneau cover 1000 to the vehicle bed 500, FIG. 14. The combination of the gaskets 140/180 and the water exit components 122 ensure a waterproof interior to the vehicle bed 500. In one embodiment, the gaskets 140/180 are bulb seals making them easily compressible to prevent water intrusion. Other gaskets such as foam or rubber with various extruded shapes were considered, but the bulb seal of the enclosed embodiment worked best in combination with limiting the gasket 140/180 compression.

Structural supports 130 are used to improve the load carrying capacity of the side access lids and match the supports 125-128 used for the panels. There are many variations of channels and materials to provide structural rigidity with the enclosed invention including aluminum strut as the best option. The geometry of strut provides superior structure compared to formed channels and allows the attachment of gear or tools without the need for additional accessory mounting channels.

FIG. 301 illustrates gear drawers 300 added to the structural supports 126 & 127, rigid or sliding operation can be offered based on the desired use. The structural supports 126/127 shown in FIG. 15, run the width of the vehicle bed 500 allowing the gear drawers 300 to be used on the driver and/or passenger sides of the vehicle. The gear drawer 300 can attach rigidly to the structural support channels 126/127. The channels chosen for this invention have a geometry that also allows the use of a trolley to attach the gear drawer 300. The use of a trolley for attachment allows the gear drawer 300 to move from passenger to driver side allowing access to the vehicle bed 500.

The side access lids 165/170 contain push to close latches 702/706 that engage with catches 210 attached on both sides as shown in FIGS. 8 & 10. This provides a unique ability to close the lids and have them latch without having to operate the lock. The enclosed embodiment uses lock cylinders 705 on the exterior of the side access lids to open as well as lock the cover.

The lock cylinder 705 is connected to cables 703/704, both of which are further connected to the push to close latches 702/706. When the lock cylinder 705 is unlocked, it rotates and pulls the push to close latches 702/706 and releases them from the catches 210 allowing the side access lids 165/170 to open. The spring-loaded push to close latches 702/706 allow the side access lids 165/170 to be closed without having to rotate the lock cylinder 705. Other lock cylinders, latches and toolbox lock rod designs can be used, but the embodiments provided show the least number of components and simplest configuration with the side access lids.

1. The aforementioned invention consists of:
A structural tonneau cover that provides security from theft while protection gear within a vehicle bed from the elements;
Is constructed with channels to divert any water intrusion from the exterior of the cover,
Is built with lids providing additional access to the bed from the side of the vehicle;
Allows additional equipment or gear to be transported on the top of the tonneau cover;
Side access lid use is not limited by the addition of a rack.
